(19) United States
(12) Patent Application Publication
(10) Pub. No.: US 2026/0056166 A1
(43) Pub. Date: Feb. 26, 2026

(54) Apparatus and Method of Using Energy Information Technology to Rapidly Evaluate an Age of an Object

(71) Applicants: Xianfa Meng, Flushing, NY (US); Angella Lu, Flushing, NY (US); Jiapeng Hao, Oakland Gardens, NY (US); Qingxi Meng, FLUSHING, NY (US); Xi Liang Liu, Flushing, NY (US); Xu XiaoWang, BeiJing (CN)

(72) Inventors: Xianfa Meng, Flushing, NY (US); Angella Lu, Flushing, NY (US); Jiapeng Hao, Oakland Gardens, NY (US); Qingxi Meng, FLUSHING, NY (US); Xi Liang Liu, Flushing, NY (US); Xu XiaoWang, BeiJing (CN)

(21) Appl. No.: 19/106,989

(22) PCT Filed: Aug. 28, 2023
(86) PCT No.: PCT/US23/31317

§ 371 Date: Feb. 26, 2025

Related U.S. Application Data
(60) Provisional application No. 63/401,270, filed on Aug. 26, 2022.

(51) Int. Cl. G01N 27/72; G01N 37/00; H04R 1/02; H04R 3/00

(52) U.S. Cl. CPC G01N 27/72; G01N 37/005; H04R 1/025; H04R 1/028; H04R 3/00; H04R 2430/01

(57) ABSTRACT

An apparatus and method for rapidly evaluating an age of an object uses energy information technology, which senses a magnetic field wave emanating from the object (i.e., an artifact), converts energy information contained within the magnetic field wave into electrical signals, and derives meaningful information (i.e., the age of the artifact) from those electrical signals. The apparatus includes a magnetic-field signal detector, a signal input circuit, a sensitivity adjustment circuit, an integrated timing circuit, an audio adjustment circuit, an audio generating circuit, a signal feedback circuit, a computing system, a speaker system, and a main housing. The circuitry portions are electronically connected amongst each other and are mounted within the main housing.

The current application claims a priority to the U.S. provisional patent application Ser. No. 63/401,270 filed on Aug. 26, 2022. The current application is filed on Aug. 28, 2023, while Aug. 26, 2023 was on a weekend.

### FIELD OF THE INVENTION

The present invention generally relates to the technical field of subtle energies and Radionics. More specifically, the present invention relates to a holographic energy Radionics device used in an object's age evaluation instrument, which can pass micro energy. A system and method for analyzing the energy information of an artifact and inferring the age of a cultural relic (artifact) by resonance evaluation.

### BACKGROUND OF THE INVENTION

From the perspective of quantum mechanics, magnetic field waves and energy waves are essentially energy fields. Collecting the quantized energy fields of different substances for analysis can obtain practical applications in many fields. The duality of particle wave and particle described by modern quantum physics, each particle has its own corresponding material wave and the wave has resonance characteristics, and the resonance of the wave is the macroscopic manifestation of quantum resonance.

Radionics is concerned with the context of control fields and “subtle energies”. The term “subtle energies” refers in this context to those forms of energy which cannot presently be objectively (physically) measured. The principles of radionics were laid down by the American doctor, Dr. Albert Abrams (1863-1924). In his theory of the “morphogenetic field”, the British biologist and philosopher Rupert Sheldrake proposed that the morphogenetic field contained all of the information about the structure and form of each bovine species, including “inanimate” material. These fields have a holographic structure, which means that the corresponding information is logically everywhere in the universe and can therefore be invoked and perceived accordingly.

Since ancient times, traditional methods of identification have been used for the identification of antiques and artifacts. The traditional appraisal method is mainly based on “ophthalmology”, which is based on the direct observation of the appraiser. It is based on the appraiser's knowledge, experience, thinking, and reasoning, as well as the appraiser's cultural accomplishment and historical knowledge, to make an appraisal conclusion on the artifacts. However, there are many problems with this empirical identification method. It is not only possible to mistake a fake one for a real one but to also mistake a real one for a fake one, so that some precious cultural relics are not protected in time. Therefore, in today's emphasis on scientific detection methods, some cultural relics (artifacts) can be replaced by modern science and technology with scientific detection methods, and complement each other with traditional identification.

In recent decades, testing instruments have become a very important auxiliary arm for the age identification of cultural relics (artifacts). Some new technologies have begun to play an important role in the identification of ancient ceramics, bronzes, and other cultural relics, but because some identification technologies can only be identified by sampling from cultural relics, they can only destroy cultural relics, so their practical application is greatly limited. Some antiquarian researchers and collectors have been expecting better techniques such as non-destructive, rapid, and accurate identification should be used in the identification of cultural relics (artifacts).

The present invention adopts the holographic year energy information resonance technology, which can directly collect the holographic energy wave dynamic signal from the object and convert it into sound (resonant sound and non-resonant sound) by sensing and capturing the change in the operator's skin impedance, and analyze the subject according to the transformed sound difference assessment. Changes in impedance are thought to use the brain's primitive sensing and signaling systems as sensors.

Pieces of prior art that relate to the prevent invention and are incorporated by reference include Japanese patent no. 1996-275928 (i.e., discloses a low frequency synthesized electromagnetic field generator), Japanese patent no. 2000-055881 (i.e., discloses a weak magnetic measurement analyzer), and an article in NeuroQuantology from March 2022 entitled “The Midbrain: Central Gray Matter is the Resonance Center of the Radionics System”.

### SUMMARY OF THE INVENTION

Aiming at the shortcomings of the prior art, the present invention provides a magnetic field wave sensing device for holographic energy information in an instrument year evaluation instrument. The present invention can effectively convert the information carried by magnetic field waves of energy information into electrical signals that can be processed by a computer by means of its unique special connection mode.

The objective of the present invention is to provide a non-destructive testing method that can be performed for cultural relics. The present invention overcomes the drawbacks of the “thermoluminescence dating method” and various “comparative dating methods” commonly used in the world. The present invention can inspect ceramics and can detect and identify various materials, such as bronzes, gold, and silver, painting and calligraphy works, jadeite, jewelry and jade, furniture and other artifacts (cultural relics) categories. The present invention can also draw an accurate conclusion that the production and production of cultural relics and artworks are accurate to “years”. The present invention has greatly improved the accuracy and timeliness of dating porcelain, jade, bronze, calligraphy, and paintings down to “year”.

The present invention is an identification method for inferring the age of cultural relics by the holographic energy information of objects, which not only has high accuracy but also has the characteristics of comprehensive, complete, simple, and fast. If necessary, the present invention can also accurately test the content of various chemical components of the objects to be authenticated.

In order to realize the above purposes, the technical realization method of the present invention is as follows: The holographic energy information magnetic field sensing device of the instrument holographic year evaluation instrument includes a detecting rod, a detecting board, an operating control board, a computer, and a power supply.

### BRIEF DESCRIPTION OF THE DRAWINGS

FIG. 1 is an illustration showing an apparatus of the present invention.

FIG. 2 is a block diagram showing the electronic components and circuitry for the apparatus of the present invention.

FIG. 3 is a continuation of FIG. 2.

FIG. 4 is an illustration showing a measuring personnel diagram using the present invention.

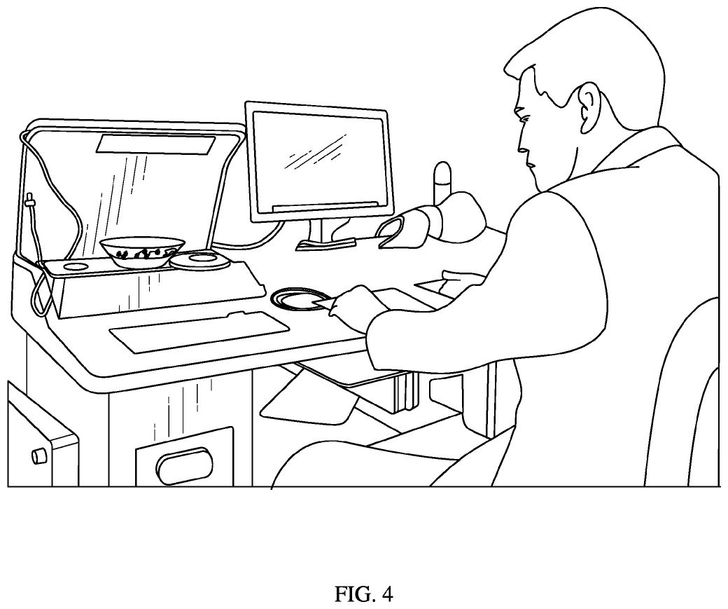

FIG. 5 is a block diagram showing an alternate embodiment for the electronic components and circuitry for the apparatus of the present invention.

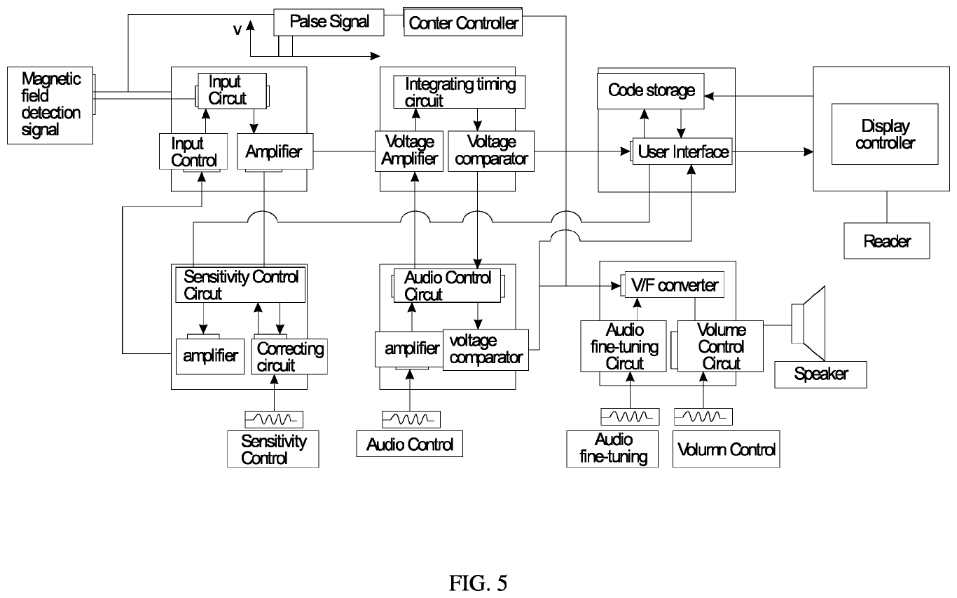

FIG. 6 is a block diagram showing another alternate embodiment for the electronic components and circuitry for the apparatus of the present invention.

FIG. 7 is an illustration showing a process of measuring a specific artifact.

FIG. 8 is an illustration showing a process of measuring another specific artifact.

FIG. 9 is an illustration showing a process of measuring another specific artifact.

FIG. 10 is an illustration showing a process of measuring another specific artifact.

FIG. 11 is an illustration showing a process of measuring another specific artifact.

FIG. 12 is an illustration showing a process of measuring another specific artifact.

FIG. 13 is an illustration showing a process of measuring another specific artifact.

FIG. 14 is an illustration showing a process of measuring another specific artifact.

FIG. 15 is an illustration showing a process of measuring another specific artifact.

FIG. 16 is an illustration showing a process of measuring another specific artifact.

### DETAILED DESCRIPTION OF THE INVENTION

All illustrations of the drawings are for the purpose of describing selected versions of the present invention and are not intended to limit the scope of the present invention.

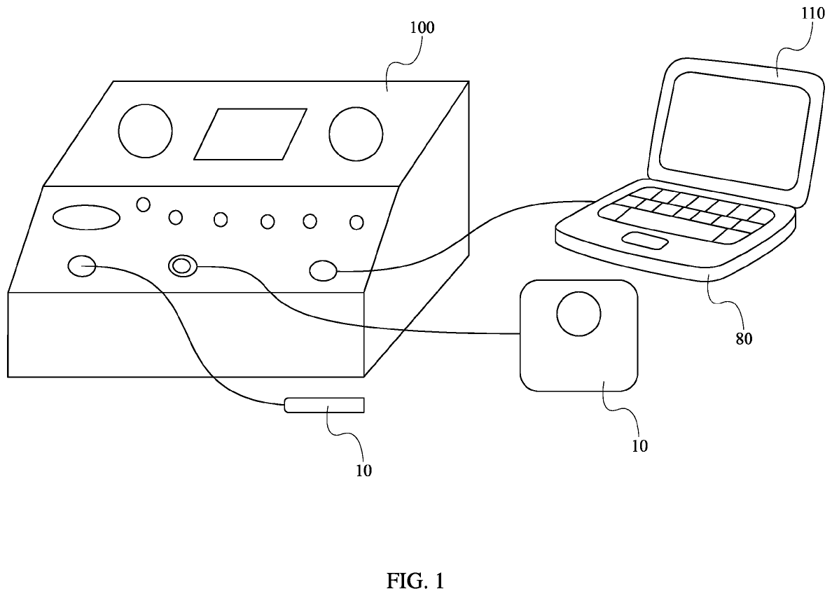

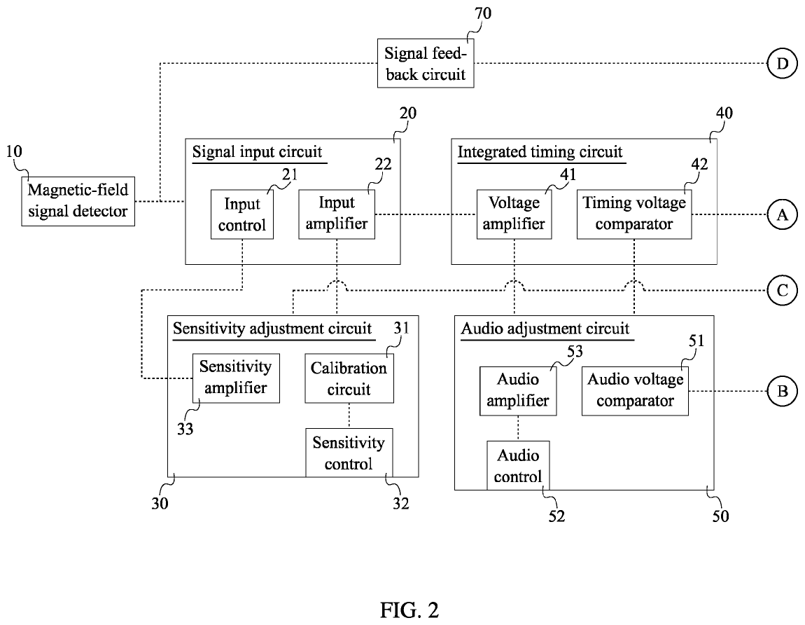

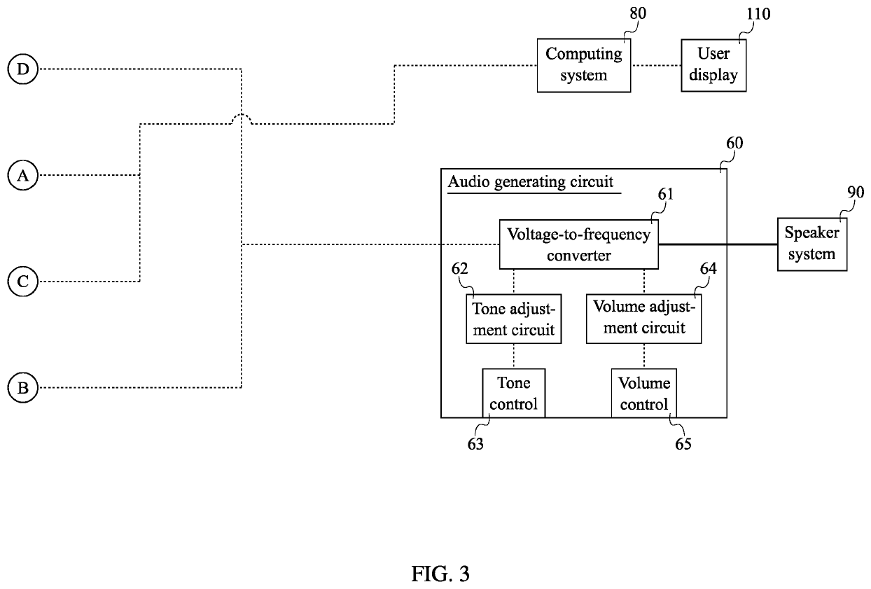

The present invention is an apparatus and method of using energy information technology to rapidly evaluate an age of an object. As can be seen in FIGS. 1-3, the apparatus of the present invention comprises a magnetic-field signal detector 10, a signal input circuit 20, a sensitivity adjustment circuit 30, an integrated timing circuit 40, an audio adjustment circuit 50, an audio generating circuit 60, a signal feedback circuit 70, a computing system 80, a speaker system 90, and a main housing 100. The magnetic-field signal detector 10 is used to sense a magnetic field wave emanating from an artifact, wherein the magnetic field wave contains energy information on the artifact and can be converted into electrical signals that allows for this energy information to be converted into a user-readable digital output. The magnetic-field signal detector 10 is preferably a pair of aluminum electrodes, which can be, but is not limited to, a probe (i.e., a detection board) and a rod (i.e., used to sense a magnetic field wave). The signal input circuit 20 is used to receive and initially process a magnetic field wave after being sensed by the magnetic-field signal detector 10. The sensitivity adjustment circuit 30 is used to adjust the sensitivity of the present invention to receive a magnetic field wave. The integrated timing circuit 40 is used to adjust and delay the signal processing of the magnetic field wave in order to optimize the signal processing of the magnetic field wave with the different circuitry portions of the present invention. The audio adjustment circuit 50 is used to dictate the kind of audio that is generated by the audio generating circuit 60 and then is outputted by the speaker system 90. The signal feedback circuit 70 is used to provide direct feedback on a magnetic field wave sensed by the magnetic-field signal detector 10. The audio generating circuit 60 is used to compile processing inputs from the different circuitry portions of the present invention into an audio output signal, which is then outputted as an audible sound with the speaker system 90. The computing system 80 is used to receive, store, and analyze information for the present invention and is used to receive, process, and execute commands for the present invention. The computing system 80 can also be used for code storage or as a user interface. The computing system 80 can be, but is not limited to, an integrated chipset, an integrated microcontroller, a personal computing device (e.g., a smartphone, a desktop, a laptop, a tablet personal computer, etc.) that is communicably coupled to the rest of the present invention, or any other kind of computing device. The main housing 100 is used to enclose all of the electronic components of the present invention and acts as a base for the other components of the present invention.

The general configuration of the aforementioned components allows the present invention to sense a magnetic field wave emanating from an artifact, to convert energy information contained within the magnetic field wave into electrical signals, and to derive meaningful information from those electrical signals. The magnetic-field signal detector 10 is electronically connected to the signal input circuit 20 and the signal feedback circuit 70, which allows the signal input circuit 20 to receive a magnetic field wave and to begin its signal processing and allows the signal feedback circuit 70 to relay direct feedback of the magnetic field wave to other circuitry portions of the present invention. The signal input circuit 20 is electronically connected to the sensitivity adjustment circuit 30 and the integrated timing circuit 40, which allows the integrated timing circuit 40 to execute its portion of the signal processing for a magnetic field wave and allows the sensitivity adjustment circuit 30 to adjust and optimize the sensitivity of the signal input circuit 20. The integrated timing circuit 40 is electronically connected to the computing system 80 and the audio adjustment circuit 50, which allows the computing system 80 to receive the signal processing of a magnetic field wave and allows the audio adjustment circuit 50 to input the signal processing of a magnetic field wave into its functionality. The sensitivity adjustment circuit 30 and the audio adjustment circuit 50 are electronically connected to the computing system 80 so that the computing system 80 can analyze information from the sensitivity adjustment circuit 30 and the audio adjustment circuit 50. The signal feedback circuit 70 and the audio adjustment circuit 50 are electronically connected to the audio generating circuit 60 so that direct feedback of a magnetic field wave from the signal feedback circuit 70 and the signal processing of the magnetic field wave from the audio adjustment circuit 50 can be used as inputs to generate an audio output signal. The audio generating circuit 60 is electrically connected to the speaker system 90 so that an audio output signal can be converted into an analog signal and outputted as an audible sound by the speaker system 90. Moreover, the magnetic-field signal detector 10 is located external to the main housing 100, while the signal input circuit 20, the sensitivity adjustment circuit 30, the integrated timing circuit 40, the audio adjustment circuit 50, the audio generating circuit 60, and the signal feedback circuit 70 are mounted within the main housing 100, and while the speaker system 90 is integrated into the main housing 100. The computing system 80 is preferably located external to the main housing 100, but the computing system 80 can alternatively be mounted within or integrated into the main housing 100.

The signal input circuit 20 may comprise an input control 21 and an input amplifier 22. The input control 21 is used to adjust how the signal input circuit 20 is receiving a magnetic field wave sensed by the magnetic-field signal detector 10. The input amplifier 22 is used to strengthen the initial signal processing done by the signal input circuit 20. Thus, the input amplifier 22 is electronically connected to a voltage amplifier 41 of the integrated timing circuit 40 and the sensitivity adjustment circuit 30. A sensitivity amplifier 33 of the sensitivity adjustment circuit 30 is electronically connected the input control 21.

The sensitivity adjustment circuit 30 may comprise a calibration circuit 31, a sensitivity control 32, and a sensitivity amplifier 33. The sensitivity control 32 is used to provide a user input to the sensitivity of the present invention at sensing a magnetic field wave. The calibration circuit 31 converts this user input into a digital instruction, and the sensitivity amplifier 33 strengthens this digital instruction before sending it back to the signal input circuit 20. Thus, the sensitivity control 32 is electronically connected to the calibration circuit 31. The sensitivity amplifier 33 is electronically connected to an input control 21 of the signal input circuit 20.

The integrated timing circuit 40 may comprise a voltage amplifier 41 and a timing voltage comparator 42. The voltage amplifier 41 is used to strengthen the initial signal processing done by the signal input circuit 20. The timing voltage comparator 42 is used to conduct a voltage analysis of the signal processing done by the integrated timing circuit 40. Thus, an input amplifier 22 of the signal input circuit 20 and the audio adjustment circuit 50 are electronically connected to the voltage amplifier 41. The timing voltage comparator 42 is electronically connected to the computing system 80 and the audio adjustment circuit 50.

The audio adjustment circuit 50 may comprise an audio voltage comparator 51, an audio control 52, and an audio amplifier 53. The audio control 52 is used to provide a user input to the kind of audio that is outputted by the present invention. The audio amplifier 53 is used to strengthen a digital instruction converted from this user input. The audio voltage comparator 51 is used to conduct a voltage analysis of the signal processing done by the audio adjustment circuit 50. Thus, the audio control 52 is electronically connected to the audio amplifier 53. The audio voltage comparator 51 is electronically connected to a voltage-to-frequency converter 61 and the computing system 80.

The audio generating circuit 60 may comprise a voltage-to-frequency converter 61, a tone adjustment circuit 62, a tone control 63, a volume adjustment circuit 64, and a volume control 65. The tone control 63 is used to provide a user input for how to adjust a tone of the audio output signal. The tone adjustment circuit 62 is used to convert this user input into a digital instruction that the present invention can use to modify the tone of the audio output signal. In addition, the volume control 65 is used to provide a user input for how to adjust a tone of the audio output signal. The volume adjustment circuit 64 is used to convert this user input into a digital instruction that the present invention can use to modify the volume of the audio output signal. The voltage-to-frequency converter 61 is electronic component that is able to convert the audio output signal (i.e., digital information) into an analog signal. Thus, an audio voltage comparator 51 of the audio adjustment circuit 50, the signal feedback circuit 70, the tone adjustment circuit 62, and the volume adjustment circuit 64 are electronically connected to the voltage-to-frequency converter 61. The voltage-to-frequency converter 61 is electrically connected to the speaker system 90. The tone control 63 is electronically connected to the tone adjustment circuit 62. The volume control 65 is electronically connected to the volume adjustment circuit 64.

The present invention may further comprise a user display 110, which allows the present invention to visually output information and analysis from the computing system 80. Thus, the user display 110 is located external to the main housing 100. The user display 110 is electronically connected to the computing system 80.

### Supplemental Description

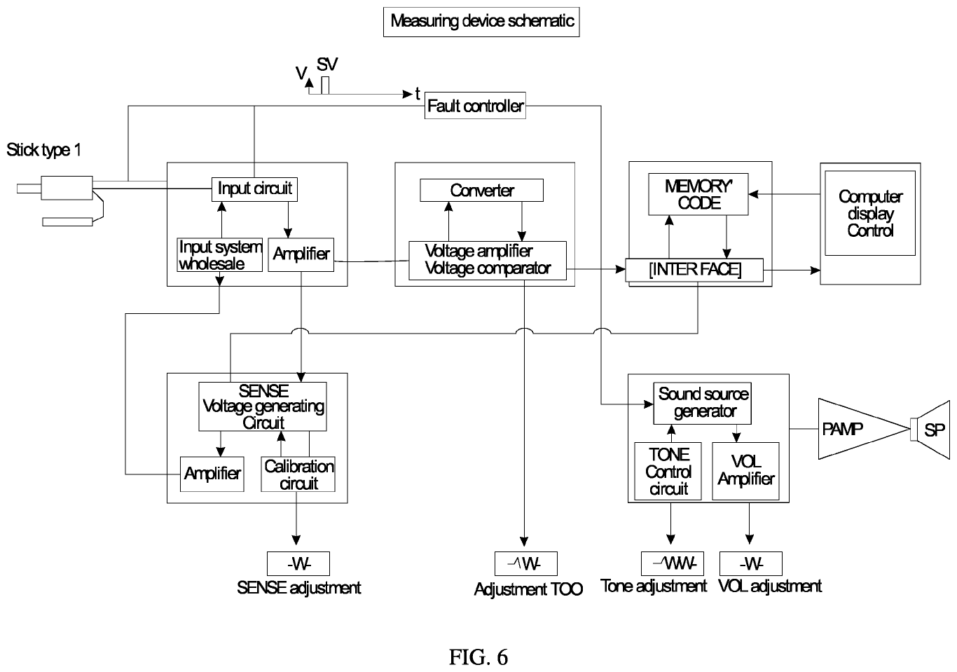

As can be seen FIG. 6, the present invention as a measurement device consists of a main body composed of a sense (SENS) voltage-generating circuit, a circuit part for detecting changes in resistance, and an acoustic source circuit, as well as a pair of aluminum electrodes (a probe and a rod) (i.e., FIG. 6, stick type at left) connected to the main body for detecting skin resistance. Its main function is to cause a negative voltage output from the SENS voltage-generating circuit to flow to the rod through the connecting cable of the probe, by fixing the output resistance of the SENS voltage-generating circuit and the input resistance of the amplifier (AMP). Changes in the skin resistance between the probe and the rod can be detected as a change in sound (i.e., change in interval).

In terms of how the present invention functions, the working principle of the invention is to adopt the energy information resonance technology, which can directly collect the holographic energy fluctuation (subtle energies) signal from the article and enter the high-sensitivity Radionics analysis device. With its unique special connection mode, the device can effectively convert the information carried by the magnetic field wave of energy information into electrical signals that can be processed by a computer. In the evaluation process, the change of the operator's skin impedance is sensed and captured, and converted into sound (resonant sound and non-resonant sound), and the object is evaluated and analyzed according to the difference in the transformed sound. Changes in skin resistance are thought to be determined by using the brain's primitive sensing functions and signaling systems as sensors. According to the degree of resonance of resonant sounds, the numerical order of the age of cultural relics (objects) will be determined and inferred.

The fluctuating energy resonance detection device of the present invention is developed by taking the change of weak energy of the artifact (cultural relic) as a device to capture the change of biological impedance. The measurement is the result of the integration of man and device. The measuring device captures the change in the operator's skin impedance relative to the measured item and converts it into sound. Presumably, the changes in impedance are used as sensors by the original sensory functions and signaling systems that judge the suitability of environmental factors necessary to maintain the operator's brain life.

The wave energy resonance detection device has been called the biological weak energy measurement device in the past. Considering the measurement principle, the measuring device is called the wave energy resonance measurement device. The measuring device is mainly used for the evaluation and application of the authenticity and manufacture year of artworks, artifacts, or cultural relics.

In terms of the development process for the present invention, the wave energy resonance measuring device is developed on the basis of the “quantum resonance detection device” by changing the oscillating electronic loop and setting the detection code system of artifacts (cultural relics). The object of measurement can not only be living organisms but also natural substances. The evaluation of artworks and artifacts (cultural relics) can not only be the overall holographic energy information analysis but also the local age information evaluation.

In terms of using the present invention as a measuring device, research as a wave energy resonance measuring device. The measuring device is composed of a SENS voltage generating circuit, a part of the circuit that detects the change of resistance, a body composed of a sound source circuit, and a pair of aluminum electrodes (probe and rod) connected to the body for detecting the resistance of the skin. Its main function is to make the negative voltage of the output of the SENS voltage-generating circuit flow to the rod through the connection cable of the probe and to generate the output resistance of the circuit and the input resistance of the AMP by fixing the SENS voltage. The change in skin resistance between the probe and the rod can be detected as a change in sound (change in the interval).

In terms of the method of measuring with the present invention, the wave energy resonance measuring device consists of a measuring device, a computer that manages the measuring device, and a printer. After placing the probe at the selected test point of the artifact (artifact) and displaying the measurement item (year test code D883) on the computer screen during the measurement, the surveyor uses the probe to evaluate, first judging BC and AD based on the resonant and non-resonant sounds produced. In the case of resonance, it is determined to be post-AD, in the case of non-resonance, it is determined to be BC.

The present invention uses a set of age detection counting rules, which include the following:
1. First, click the code of the item to be detected, and after the data is returned to zero, the COUNT value will be displayed in the one bit of the count window.
2. Once the positive number 1 or more is entered in the unit position of the COUNT window, the resonance sound and non-resonance sound will be reversed immediately.
3. Each increase in a value, when the resonance or non-resonance sound is still unchanged, the tester can continue to increase the value, the same as ten, hundred, thousand, and so on.
4. When a new value is added, the resonant sound and the non-resonant sound immediately reverse, and the count stops. At this time, the value displayed is the detection result.

In terms of a measurement principle used by the present invention, from the perspective of quantum mechanics, magnetic fields and energy waves are essentially energy fields. Collecting and analyzing the quantized energy fields of different substances can obtain practical applications in many fields. The duality of particle, wavelet, and particle described by modern quantum physics, each particle has its own corresponding material wave, and the wave has resonance characteristics, and the resonance of the wave is the macroscopic embodiment of quantum vibration.

Through the wave energy resonance measuring device, it is possible to capture and analyze the wave information of weak matter-energy (subtle energies) in artworks, artifacts, or cultural relics. For the energy information of such a weak magnetic field, Fourier analysis is carried out first, and the information of subtle energies of various kinds of artifacts is compiled into a four-digit code starting with an English letter, and the code is called out during detection. The detection code can also be expanded according to needs. By measuring the resonance range between the sample and the code, the present invention can make corresponding judgments.

The resonant and non-resonant signals are output in the form of sound through the wave energy resonance measuring device. When subtle energies are chaotic, the non-resonant sounds with echo will be sent out, while when subtle energies are not chaotic, the resonant sounds without echo will be sent out. The processing year of the instrument can be judged according to whether there is an echo.

In terms of measuring items with the present invention, according to the classification of different materials to determine the selection of evaluation code, such as porcelain type code D126, jade type D153, metal type E182, painting and calligraphy type F068, and so on, the test will be the code out for analysis and comparison, evaluation of the age of cultural relics.

In terms of code creation for the present invention, the weak electromagnetic energy of the measuring object perceived by the measuring person is captured as a sense and converted into a sense of an identifying symbol (character, number) and used as an identification number or code when measuring.

More specifically, the code creation for the present invention includes the following. The item (cultural relic) is placed on the detection board. The registration requires the test name (test item), and a clear description of the test object. The first place starts with 26 letters in English, and the detection and evaluation are respectively conducted to find the letter with the most clear resonance sound to determine the first place of the detection code. Then the 0-9 Arabic numerals are detected and judged, the clearest resonant sound is selected, and the number is determined as the second digit of the detection code, and so on, and finally the four-digit code number of the evaluation project is generated.

During the identification and detection process, when the specific four-digit energy magnetic field information code is input into the instrument year evaluation instrument, the magnetic field fluctuation information sent by probe rod is compared with the computer to determine its resonance degree.

In terms of the technical mastery of the present invention, since the biometric resonator uses the sensor's usually unconscious perception through a linkage with consciousness, a certain period of training is required in order to develop a sense of recognition of biometric information.

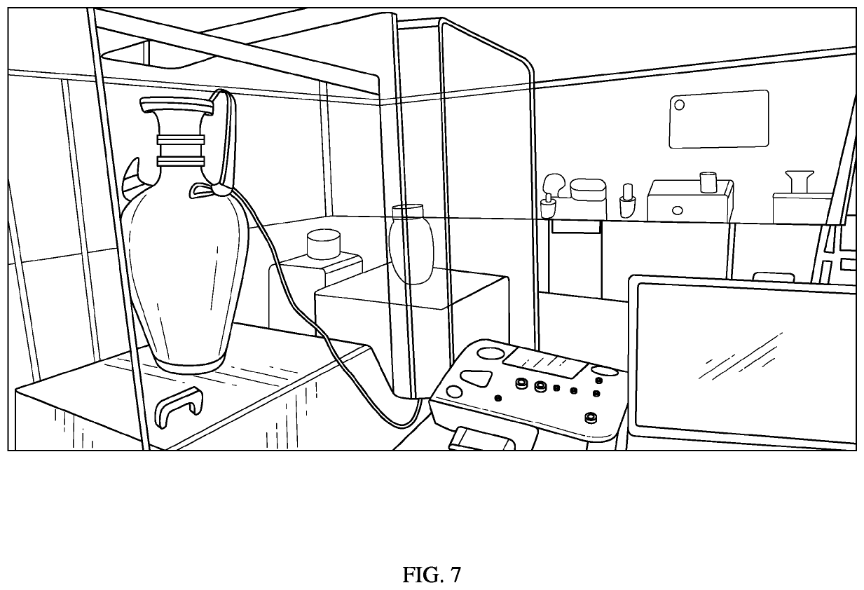

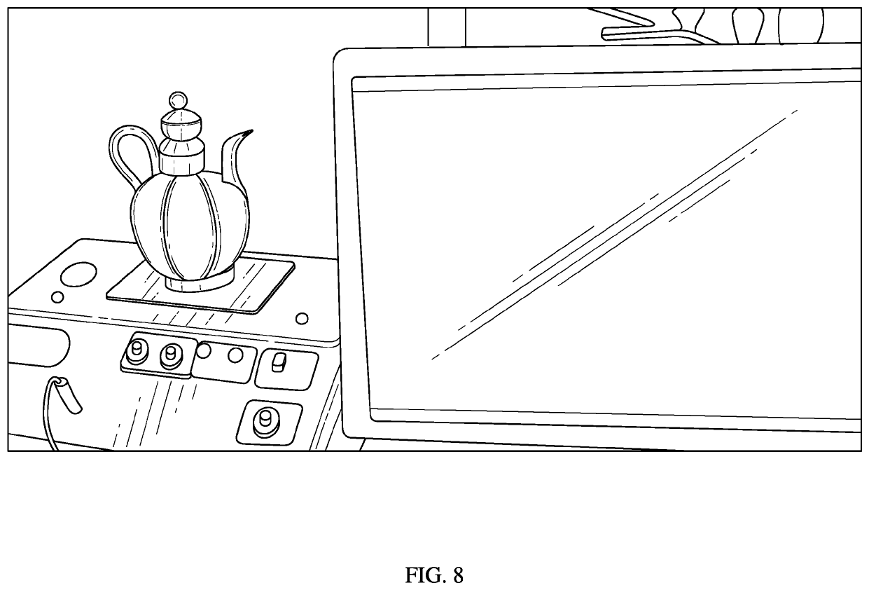

In terms of the measurement practice for the present invention, the name of the measuring item is “Yueyao Longba Chicken Head Pot (Pot King)”, the height is 97 cm, and the conclusion is 79 BC, dated to the Western Han Dynasty of China (see FIG. 7). The name of the measured item is “Yueyao Mise Cihuahua Shileng, handled pot”, the height is 20 cm, and the conclusion is “959 AD, the date is the end of the Five Dynasties of China” (see FIG. 8).

The specific operation flow of the present invention is as follows:
1. During the sample test preparation, place the test standard sample on the probe board or use the probe rod to place it on the tested item. After placing the standard sample, clean up contact with other objects and the human body. During the test, do not move the standard sample.
2. During the equipment preparation, start the power supply of the host computer and the monitor, turn on the power switch of the detector, and enter the test program. Enter the code (classification code of different materials) to retrieve the required code name.
3. Start the detection of the inspected item.
4. During selection of test point, number of test points: there are no less than 3 test points for each piece of standard sample. Determine 1 to 3 detection points on the main body of each inspected item. For the main body of articles with signatures, inlays, engravings, inscriptions, seals, inscriptions, and other attachments, determine more than 1 detection point at the place with standard sample characteristics.
5. During the test process, establish the location of the test points according to the test report and carry out the test year by year. In the process of detection, the resonance between the standard sample and the code is determined, and the signal is output in the form of sound. The test steps should be completed in the order of testing the standard sample body, first outside and then inside. Next, test the parts with standard sample characteristics attached to the standard sample body and finish in the order of first up and then down.
6. In order to determine the end of the test, when testing standard samples, the present invention will sound resonant and non-resonant sounds, single sound is the resonant sound and double sound is the non-resonant sound. When the present invention changes from double sound to single sound feedback information in the testing process, the testing of the standard sample under test is finished. The production and production year of the item are displayed in the testing data of the present invention.

The analysis and judgment will be carried out to issue the evaluation report (i.e., see Table 1).

TABLE 1
Evaluation and analysis report of energy information of cultural relics (artifacts)

Sending From:

| Testing | Testing From: | | | | | |
|---|---|---|---|---|---|---|
| device | | | | | | Inner |
| number | Length | Width | Height | Thickness | Diameter | Diameter |
| Object name | | | | | | |
| Location of | A | B | C | D | E | F |
| test points | | | | | | |
| The sum of | | | | | | |
| test points | | | | | | |
| Test Result | A | B | C | D | E | F |
| Test | | | | | | |
| conclusions | | | | | | |
| Remarks | | | | | | |

Test Date: Year Month Day

The evaluation report of the present invention is as follows:
1. Through the testing of the equipment, it shows the production and production year of the inspected items, that is, it can interpret the processing and production time of the items, and realize the accurate judgment of the new and old items.
2. After the inspected item is tested, if the main detection data and the main body are attached to the main body of the item, there is an item characteristic. If the test data is consistent, the production year of the inspected item can be determined.
3. After the inspected articles are tested, if the testing data of the main body is inconsistent with the testing data of the special part of the main body attached to the main body of the articles, there is information that the articles made in different years are joined together or the articles are affected by secondary external forces, the production year information of different test parts of the articles should be provided.

In terms of test verification and statistical analysis for the present invention, ensuring accuracy is accomplished by testing 30 samples of different materials and their age with a double-blind method and the object's age detector. The results of detection were compared with those of qualified professional identification experts, and the detection error rate and year error rate were calculated.

The detection error rate is calculated according to formula (1):

$${E}_{r} = \frac{{E}_{a}}{T} \times 100 \%$$

wherein Eᵣ is the error rate, Eₐ is the absolute error, and T is the true value.

In terms of repeatability for the present invention, 3 samples were selected and tested 10 times with the object's age detector. The measured values were read and calculated according to formula (2):

$${C}_{v} = \frac{\sqrt{\frac{{\sum }_{i = 1}^{n} {x}_{i} - {( {\sum }_{i = 1}^{n} {x}_{i} )}^{2} n}{n} - 1}}{\frac{{\sum }_{i = 1}^{n} {x}_{i}}{n}} \times 100 \%$$

wherein Cᵥ is repeatability, xᵢ is a first measured value, and N is the number of consecutive measurements.

As mentioned above, in one embodiment of the present invention, an artifact age evaluation analyzer is used to measure the age and date of the subject, and the material combination of the artifact can also be detected by the analyzer. The evaluation analysis method not only has a high degree of accuracy but also has the characteristics of comprehensive, complete, simple, and fast.

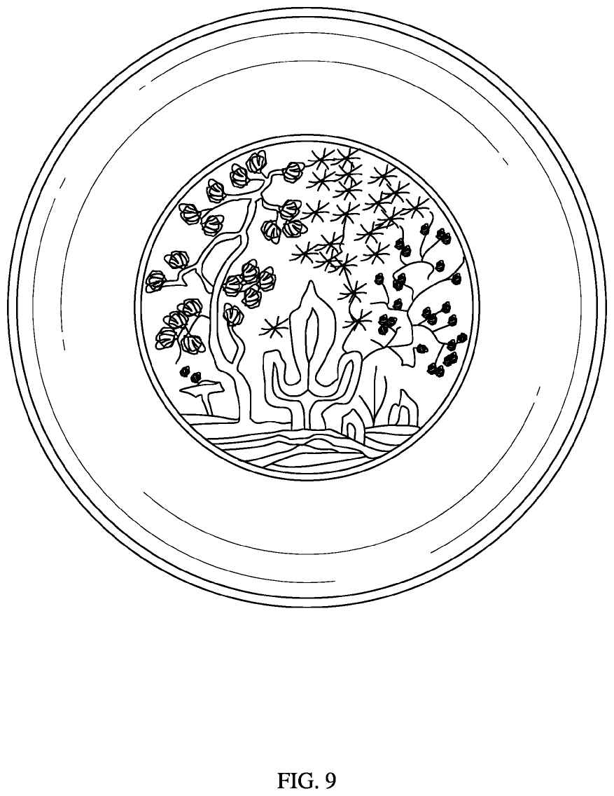

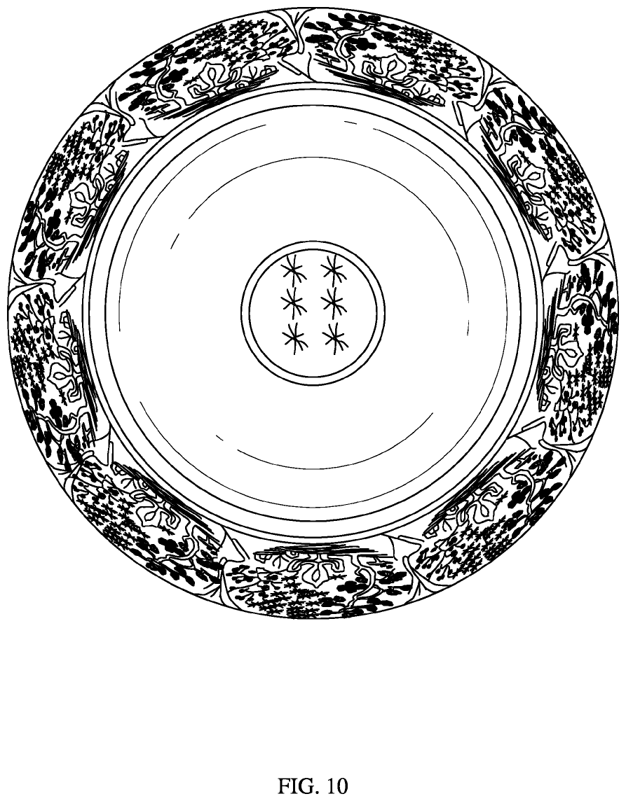

One test example is the DaMing Xuande Nianzhikuan Qinghua Neisong Zhumeiwai Shi Nv pattern plate, which has a diameter of 19.5 cm and a height of 4.5 cm. As can be seen in FIGS. 9 and 10, the test results concluded that the year of manufacture was 1427 AD±30 years for the porcelain embryo and 1429 AD±30 years for the porcelain glaze.

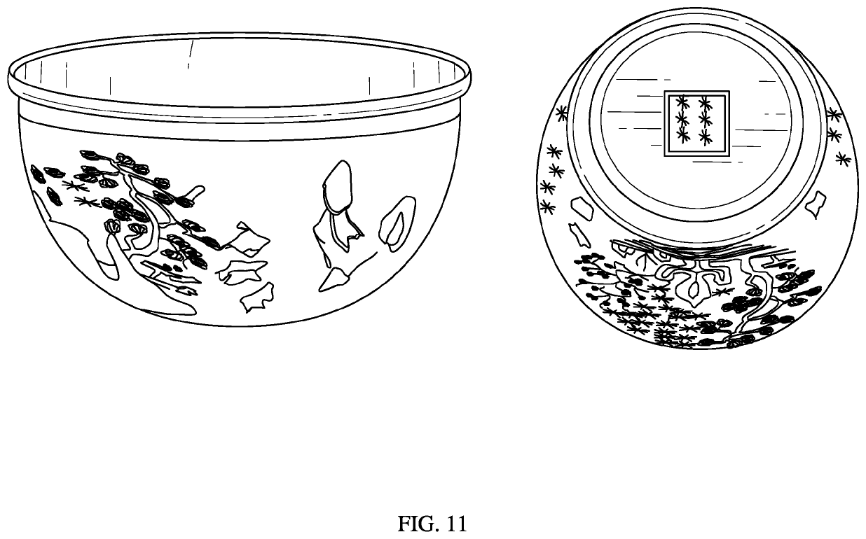

As can be seen in FIG. 11, another test example is the Mingchenghuakuan Doucai Chicken Cup, which is made of porcelain, has a diameter of 81 mm, and has a height of 43 mm. The appraisal's conclusion of this example was that the year of manufacture is 1468 AD.

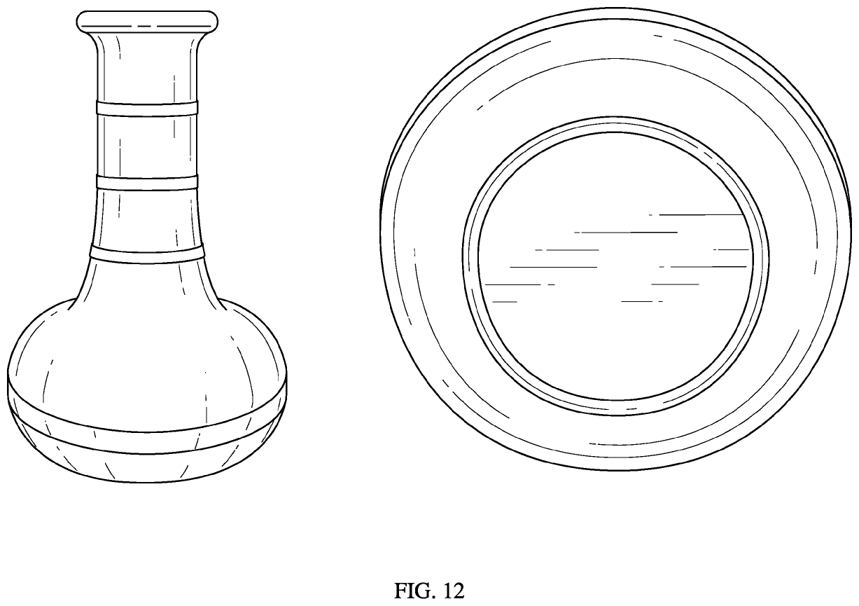

As can be seen in FIG. 12, another test example is the Ruyao TianqingYou Changjing Xuan pattern bottle, which is made of porcelain, has a diameter of 170 mm, and has a height of 110 mm. The appraisal's conclusion of this example was that the year of manufacture is 962 AD.

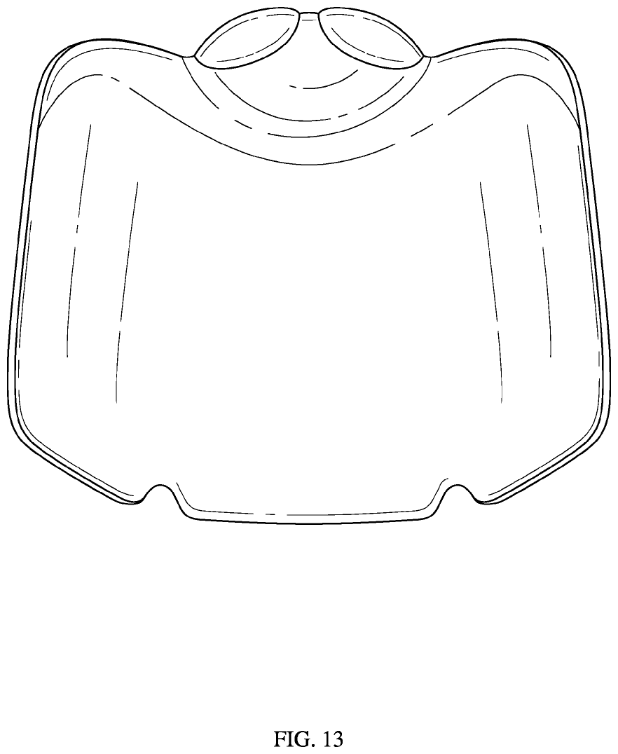

As can be seen in FIG. 13, another test example is the Yuxiao pendant, which is made of jade, has a diameter of 39 mm, and has a thickness of 16 mm. The appraisal's conclusion of this example was that the year of manufacture is 1900 BC.

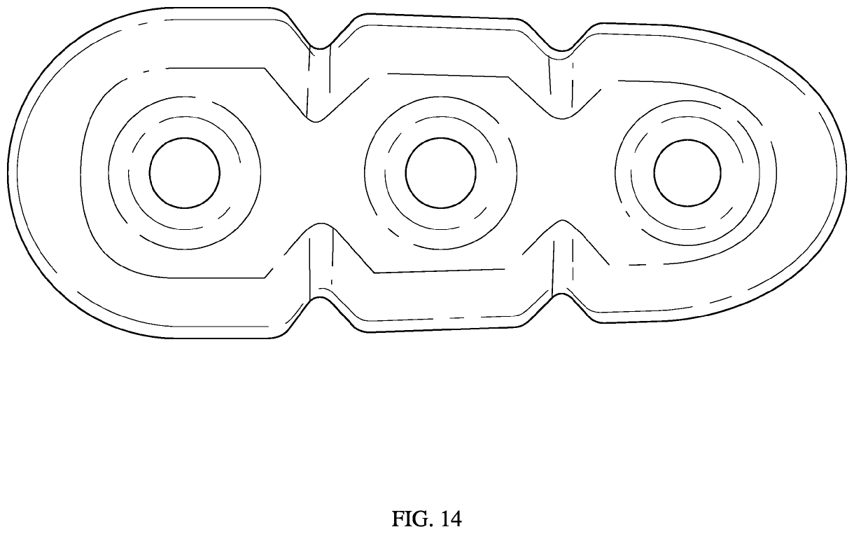

As can be seen in FIG. 14, another test example is the Green Three Kong jade plate, which is made of jade, has a diameter of 39 mm, has a width of 49 mm, and has a thickness of 16 mm. The appraisal's conclusion of this example was that the year of manufacture is 1300 BC.

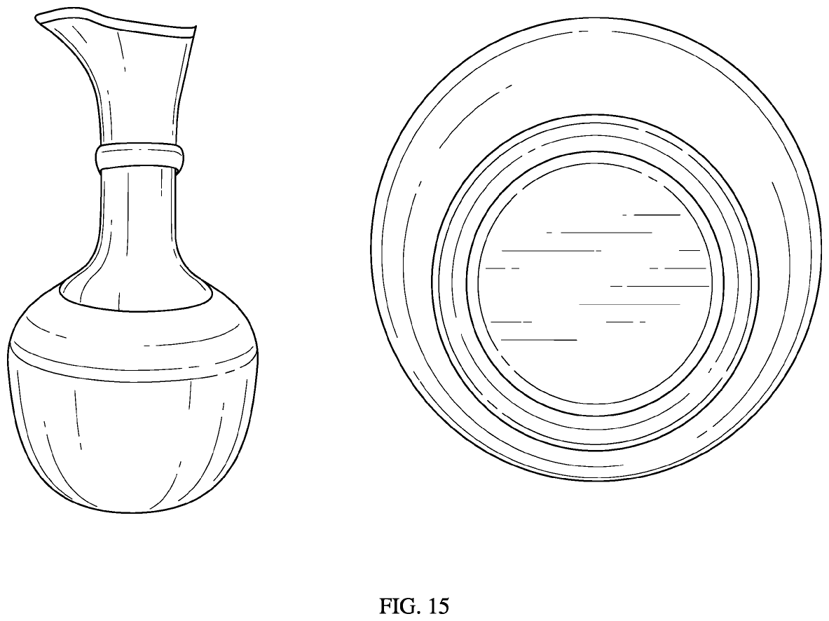

As can be seen in FIG. 15, another test example is the Ruyao Lanyou Xuanwen Duck Mouth bottle, which is made of porcelain, has a diameter of 190 mm, and has a height of 100 mm. The appraisal's conclusion of this example was that the year of manufacture is 930 AD.

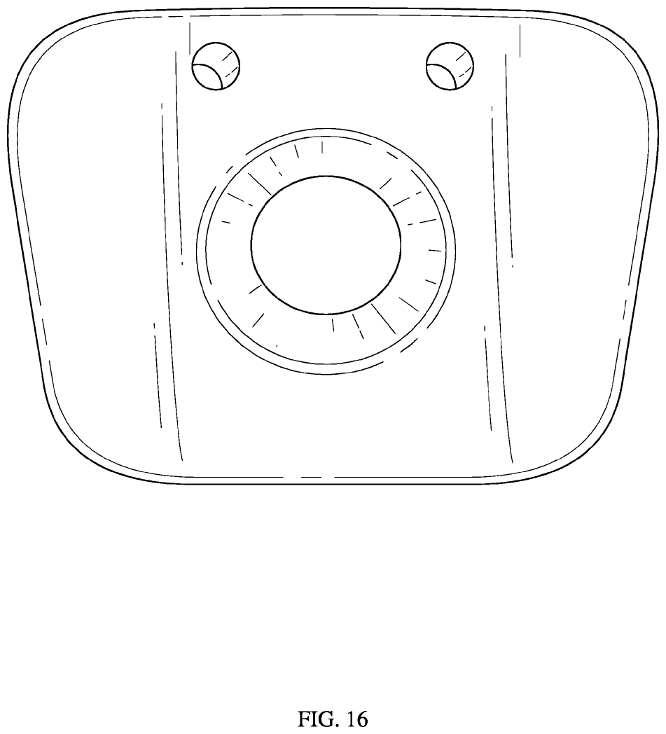

As can be seen in FIG. 16, another test example is the Green Trapezoid Three Kong Jade, which is made of jade, has a diameter of 75 mm, a width of 56 mm, and has a thickness of 4 mm. The appraisal's conclusion of this example was that the year of manufacture is 1200 BC.

In practice, the accuracy of the test results is more than 95%, but some of the deficiencies include the following:
1. The operation of detection personnel is not standardized;
2. Because of its sensitive detection signal, the magnetic field, electric field, and other radiation of the peripheral environment may interfere with the year information captured by the measured item or equipment;
3. The items themselves are affected to a certain extent, such as excessive cleaning, grinding, radiation, humidity, etc.

Based on the above objective factors, the tolerance value of 20 years can be given for the age evaluation results of cultural relics (artifacts), which can provide a more objective identification reference.

Although the invention has been explained in relation to its preferred embodiment, it is to be understood that many other possible modifications and variations can be made without departing from the spirit and scope of the invention as hereinafter claimed.

What is claimed is:

1. An apparatus using energy information technology to rapidly evaluate an age of an object, the apparatus comprising:
a magnetic-field signal detector;
a signal input circuit;
a sensitivity adjustment circuit;
an integrated timing circuit;
an audio adjustment circuit;
an audio generating circuit;
a signal feedback circuit;
a computing system;
a speaker system;
a main housing;
the magnetic-field signal detector being electronically connected to the signal input circuit and the signal feedback circuit;
the signal input circuit being electronically connected to the sensitivity adjustment circuit and the integrated timing circuit;
the integrated timing circuit being electronically connected to the computing system and the audio adjustment circuit;
the sensitivity adjustment circuit and the audio adjustment circuit being electronically connected to the computing system;
the signal feedback circuit and the audio adjustment circuit being electronically connected to the audio generating circuit;
the audio generating circuit being electrically connected to the speaker system;
the magnetic-field signal detector being located external to the main housing;
the signal input circuit, the sensitivity adjustment circuit, the integrated timing circuit, the audio adjustment circuit, the audio generating circuit, and the signal feedback circuit being mounted within the main housing; and
the speaker system being integrated into the main housing.

2. The apparatus as claimed in claim 1, wherein the magnetic-field signal detector is a pair of aluminum electrodes.

3. The apparatus as claimed in claim 2, wherein the pair of aluminum electrodes is a probe and a rod.

4. The apparatus as claimed in claim 1 comprising:
the signal input circuit comprising an input control and an input amplifier;
the input amplifier being electronically connected to a voltage amplifier of the integrated timing circuit and the sensitivity adjustment circuit; and
a sensitivity amplifier of the sensitivity adjustment circuit being electronically connected the input control.

5. The apparatus as claimed in claim 1 comprising:
the sensitivity adjustment circuit comprising a calibration circuit, a sensitivity control, and a sensitivity amplifier;
the sensitivity control being electronically connected to the calibration circuit; and
the sensitivity amplifier being electronically connected to an input control of the signal input circuit.

6. The apparatus as claimed in claim 1 comprising:
the integrated timing circuit comprising a voltage amplifier and a timing voltage comparator;
an input amplifier of the signal input circuit and the audio adjustment circuit being electronically connected to the voltage amplifier; and
the timing voltage comparator being electronically connected to the computing system and the audio adjustment circuit.

7. The apparatus as claimed in claim 1 comprising:
the audio adjustment circuit comprising an audio voltage comparator, an audio control, and an audio amplifier;
the audio control being electronically connected to the audio amplifier; and
the audio voltage comparator being electronically connected to a voltage-to-frequency converter and the computing system.

8. The apparatus as claimed in claim 1 comprising:
the audio generating circuit comprising a voltage-to-frequency converter, a tone adjustment circuit, a tone control, a volume adjustment circuit, and a volume control;
an audio voltage comparator of the audio adjustment circuit, the signal feedback circuit, the tone adjustment circuit, and the volume adjustment circuit being electronically connected to the voltage-to-frequency converter;
the voltage-to-frequency converter being electrically connected to the speaker system;
the tone control being electronically connected to the tone adjustment circuit; and
the volume control being electronically connected to the volume adjustment circuit.

9. The apparatus as claimed in claim 1 comprising:
the computing system being located external to the main housing.

10. The apparatus as claimed in claim 1 comprising:
a user display;
the user display being located external to the main housing; and
the user display being electronically connected to the computing system.
